(19) United States
(12) Patent Application Publication
(10) Pub. No.: US 2008/0166674 A1
(43) Pub. Date: Jul. 10, 2008

(54) Temperature control method

(76) Inventor: William C. Pfefferle, Madison, CT (US)

Correspondence Address: Robert L. Rispoli;Precision Combustion Inc., 410 Sackett Point Road, North Haven, CT, 06473, US

(21) Appl. No.: 11/652,201

(22) Filed: Jan. 10, 2007

(51) Int. Cl. B01J 8/00

(52) U.S. Cl. 432/29; 422/129

(57) ABSTRACT

The invention provides a method for limiting the temperature of the catalyst in exothermic mass-transfer-limited reactions by placing a flow-through catalyst in thermal contact with a downstream non-catalytic flow-through structure placed in the flow stream whereby a portion of the heat-of-reaction is transferred to the downstream non-catalytic structure.

### FIELD OF THE INVENTION

This invention relates to improved systems for control of catalyst temperature in exothermic reactions. In one particular embodiment, this invention relates to a method to transfer heat from a catalyst to a non-catalytic body.

### BACKGROUND OF THE INVENTION

It is well known that in mass transfer limited adiabatic catalytic reactions, the catalyst operates at or close to the adiabatic reaction temperature, even at low percent conversion. This is because heat and mass transfer are related. However, many exothermic catalytic processes require operation of the catalyst at a temperature lower than the adiabatic reaction temperature.

In combustion systems, for example, the required adiabatic combustion temperature is typically well above the maximum allowable temperature of available catalyst materials. In selective catalytic reactions, as for example in the reaction of ethylene with oxygen to produce ethylene oxide, selectivity is impaired if catalyst temperature is not controlled. Thus, backside cooling has been employed in catalytic combustion systems. This has the disadvantage of requiring placement of the catalyst on the heat transfer cooling surface.

In another prior art system such as in chemical reactors, particulate catalyst structures (often pellets) are loaded into cooled tubular reactors. In contrast to the backside cooled reactor, this allows catalyst replacement without replacing the reactor. Unfortunately, only catalyst in contact with the reactor walls is directly cooled. The present invention overcomes the limitations of these prior art systems.

### SUMMARY OF THE INVENTION

In the present invention, catalyst temperature in mass-transfer-limited exothermic reactions is limited by providing an additional heat transfer mechanism. By thermal contact with a non-catalytic flow through structure to which reaction heat is transferred cooling the catalyst. The transferred heat flows to the flowing fluid from the non-catalytic structure. Catalyst temperature is lowered because the heat release on the catalyst is determined by the mass transfer rate to the catalyst but heat transfer from the catalyst is augmented by transfer to the flowing gas stream via an additional non-catalytic flow unit.

Additional cooling may be achieved by placing a non-catalytic heat sink element before, as well as following, each catalyst element. The number of flow-through catalyst/non-catalytic structure assemblies used is chosen to achieve the desired conversion level. For selective chemical conversions, the assemblies are spaced apart in a cooled reaction vessel, typically tubular, such that the inlet temperature to each assembly is limited to a predetermined value by heat transfer from the flow to the vessel walls. Advantageously, the catalyst flow paths should be short enough to allow the desired degree of heat transfer to the downstream heat sink structure(s).

The optimum length of the catalyst flow paths will depend on the flow channel diameter and the thermal conductance of the channel walls. Channels will be less than about ten mm in length but are typically shorter. Short channel length catalysts are preferred. Optionally for maximum thermal conductivity, the catalyst may be an integral part of the inlet portion of the non-catalytic structure. However, separate structures enable replacement of the catalyst section with retention of the downs structures.

### BRIEF DESCRIPTION OF THE DRAWINGS

The figures provide a schematic of catalyst/non-catalytic structure assemblies.

FIG. 1 shows a series of close packed assemblies in cylindrical form for partial oxidation of a hydrocarbon to produce hydrogen.

FIG. 2 shows a section of an ethylene oxide reactor having spaced apart axial catalyst/non-catalytic structure assemblies.

### DETAILED DESCRIPTION OF THE INVENTION

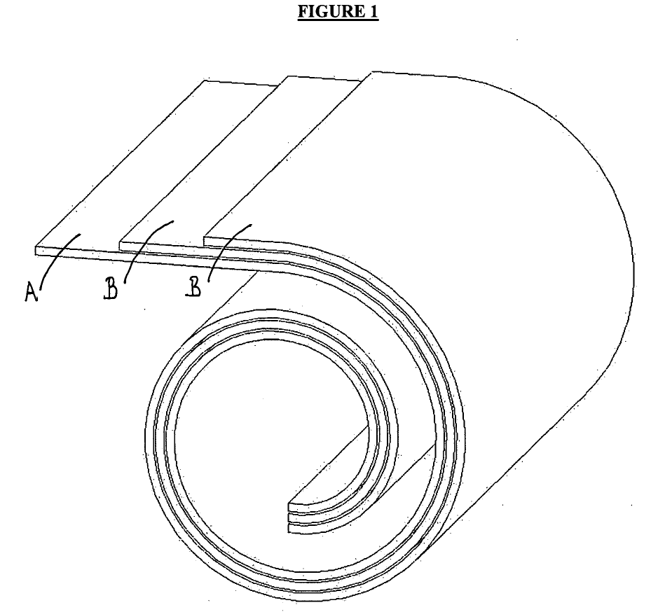

In FIG. 1, an assembly of catalytic screen A and two non-catalytic screens B are rolled to form a tubular reactor for radial outward flow. Sufficient layers are used to accommodate the exothermic reaction section of a catalytic partial oxidation (CPOX) of hydrocarbon with oxygen to produce the heat for a following endothermic reforming section. As shown the layers are in close proximity to allow good thermal contact between layers A and B. In production of hydrogen by partial oxidation, the initial reaction is highly exothermic followed by the endothermic consumption of remaining fuel. Temperature is highest near the reactor inlet and decreases towards the outlet. Thus, catalyst cooling is not needed except during the exothermic reaction of oxygen.

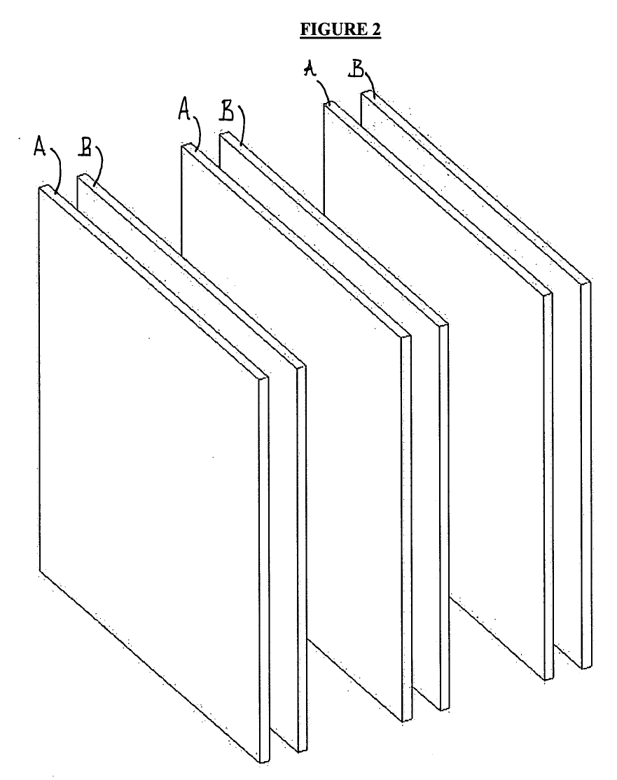

In FIG. 2, a series of packets A and B are shown in axial flow spaced apart relation to allow inter packet cooling of the gas flow. Alternately, the packets may be close packed.

While the present invention has been described in considerable detail, other configurations exhibiting the characteristics taught herein for an improved method for temperature control of a catalyst are contemplated. Therefore, the spirit and scope of the invention should not be limited to the description of the preferred embodiments described herein.

What is claimed is:

1. A catalytic reactor comprising a plurality of catalyst and non-catalytic structure assemblies.

2. The reactor of claim 1 wherein the assemblies are close packed.

3. The reactor of claim 1 wherein the assemblies are spaced apart.

4. The reactor of claim 1 comprising assemblies in which the catalyst and the non-catalytic structure are close packed.

5. The reactor of claim 1 comprising assemblies in which the catalyst and the non-catalytic structures are spaced apart.

6. The reactor of claim 1 comprising assemblies wherein the catalyst comprises the inlet portion of the non-catalytic structure.

7. A method of limiting the temperature of a catalyst in exothermic mass-transfer-limited reactions comprising:
a) placing a flow-through catalyst in thermal contact with a downstream non-catalytic flow-through structure placed in the flow stream;
b) passing a reaction mixture into contact with the catalyst for reaction and generating a reacted mixture and a heat of reaction; and
c) whereby a portion of heat of reaction is transferred to the downstream non-catalytic structure.

8. The method of claim 7 wherein heat is transferred from the catalytic structure to the downstream non-catalytic structure by thermal contact conduction.

9. The method of claim 7 wherein heat is transferred from the catalytic structure to the downstream non-catalytic structure by radiation.

10. The method of claim 7 comprising the additional step of cooling the reacted mixture by heat exchange with a cooling fluid.

11. The method of claim 7 wherein the reacted mixture passes through the downstream non-catalytic structure and into contact with one or more additional catalytic elements.

12. The method of claim 11 wherein the additional catalytic elements are flow-through catalysts in thermal contact with a non-catalytic structure.
